(19) United States
(12) Patent Application Publication
(10) Pub. No.: US 2003/0016545 A1
(43) Pub. Date: Jan. 23, 2003

(54) Buck regulator with adaptive auxiliary voltage flyback regulator

(75) Inventors: Mark A. Jutras, Upton, MA (US); Mark S. Masera, Grafton, MA (US)

Correspondence Address: OSTROLENK FABER GERB & SOFFEN, 1180 AVENUE OF THE AMERICAS, NEW YORK, NY, 100368403

(73) Assignee: Bel-Fuse, Inc.

(21) Appl. No.: 10/159,699

(22) Filed: May 30, 2002

Related U.S. Application Data
(60) Provisional application No. 60/296,067, filed on Jun. 5, 2001.
(60) Provisional application No. 60/312,229, filed on Aug. 14, 2001.

(51) Int. Cl. H02M 3/335

(52) U.S. Cl. 363/18

(57) ABSTRACT

A DC/DC converter which includes a switched mode power supply, such as a switched mode buck regulator, has gate driven switching devices. A flyback converter is provided for providing a gate drive voltage to the gate driven switching devices. The flyback converter increases or decreases an input voltage to provide the gate drive voltage. A programmable under voltage lockout circuit is provided for turning ON of the flyback converter if the input voltage is lower than a predetermined value. A plurality, n, of buck regulators are connected in parallel and are controlled by a common controller which provides pulse width modulation signals to each power stage which are shifted by 360°/n from each other.

### CROSS REFERENCE TO RELATED APPLICATIONS

This application is based on and claims priority to U.S. Provisional Application No. 60/296,067, filed Jun. 5, 2001, entitled “DIGITAL-TO-DIGITAL CONVERTER” and U.S. Provisional Application No. 60/312,229, filed Aug. 14, 2001, entitled “BUCK REGULATOR DC/DC CONVERTER WITH ADAPTIVE AUXILIARY VOLTAGE FLYBACK REGULATOR AND USER PROGRAMMABLE UNDER VOLTAGE LOCKOUT”, the entire disclosures of which are incorporated by reference herein.

### BACKGROUND OF THE INVENTION

This invention relates to power conversion devices, such as DC/DC converters and, more particularly, to switching buck regulator DC/DC converters that employ gate-driven switching devices, such as MOSFETs.

A basic prior art buck regulator DC/DC converter is shown in FIG. 1A. This is a well known topology that produces an output voltage equal to the input voltage multiplied by the duty cycle of the signal used to turn the gate of a MOSFET transistor Q1 ON and OFF. In the buck regulator of FIG. 1A, the forward conduction path is through Q1 and refers to the path the current through L1 takes when the switch Q1 is turned ON. The free wheeling conduction path is through the diode D1 and refers to the path that the current through the inductor L1 takes when the transistor Q1 is OFF.

A feedback control circuit (not shown) may be used to modify this duty cycle with an error voltage to produce a regulated, non-isolated, DC/DC converter. Using an amplifier to compare the output voltage of the converter to a fixed reference generates such an error voltage. The control circuit is typically referred to as a pulse width modulator (PWM).

When a PWM circuit is used to control Vout by means of closed loop feedback, the output voltage will be proportional to a reference and the average current through the inductor L1 will equal the average current delivered to the load.

FIG. 1B is the same basic buck regulator circuit as that in FIG. 1A except that the diode D1 is replaced with a MOSFET Q2. The circuit used to control this implementation holds Q2 OFF while Q1 is ON and visa versa. The circuit in FIG. 1B is typically referred to as a synchronous buck regulator.

FIG. 2 summarizes the basic waveforms of operation for the circuit in FIG. 1B, where mᵤₚ is the up slope of the triangular waveform and m_{down} is the down slope.

The PWM circuitry and the circuitry used to drive the gates of the switching transistors require a voltage source to operate. FIGS. 3A to 3F are block diagrams of alternatives for providing gate drive voltage. Components in FIGS. 3A to 3F performing the same or similar functions as those in FIGS. 1A and 1B are designated with the same reference characters or numbers.

FIG. 3A is a prior art implementation in which conventional gate drive circuits, U1 and U2, are used to interface the PWM signal to the gates of the MOSFETs, Q1 and Q2. When one of the transistors is commanded on by the PWM signal the corresponding gate drive block will deliver a voltage to the gate approximately equal to V_Gate_Bias. To turn on Q1 a gate voltage must be applied that is greater than its source voltage by the specified threshold voltage for the device. The circuit in FIG. 3A will work provided that a V_Gate_Bias voltage is available that is greater than Vin. When Q1 is ON, Vin is applied to the LC filter circuit. When Q1 is OFF it is necessary to turn Q2 ON so that the current in the inductor L1 has a path to flow. So when Q1 is turned OFF, Q2 is turned ON. Since Q1 and Q2 are connected in series across Vin, it is necessary to make sure that Q1 is OFF before turning Q2 ON and visa versa. A timing logic circuit 22 is used to assure this “break” before “make” sequence occurs when turning Q1 and Q2 ON and OFF. Generally, the timing logic circuit 22 and the gate drive circuits U1 and U2 are inclusive in industry standard gate drive IC's like the Intersil HIP6601.

When a V_Gate_Bias voltage greater than Vin is not available one of the circuits in FIGS. 3B through 3F is typically used.

The circuit in FIG. 3B. uses a gate drive transformer T₁ to couple a voltage scaled by the transformer's turns ratio through an interface circuit 24 to the gate of Q1.

The circuit in FIG. 3C. references the source of Q1 to Vout. Since Vin is typically higher than Vout by more than the required gate drive voltage this circuit can use Vin as V_Gate_Bias. The disadvantage of this topology is the fact that L1 requires a separate winding to establish the freewheeling path. At high output current the non-perfect coupling between the windings on L1 make this circuit impractical.

The circuit in FIG. 3D moves the input voltage to C2 when Q2 is ON. Since C2 is referenced to the node where Q2's drain and Q1's source meet, the voltage on the topside of C2 will represent a gate drive voltage that is referenced to the source of Q1. In this case, as long as Vin is high enough to drive the gate of Q1 no other voltage is required.

The circuit in FIG. 3E is a basic voltage doubler which can be used to generate a V_Gate_Bias for Q1 that is higher than Vin. (V_{—Gate}_Bias=2*(Vin−Vfwd)). More specifically, the PWM signal is periodic and is used to turn Q1 ON when Q2 is OFF and visa versa. The resulting rectangular waveform at the node where the source of Q1 connects to the drain of Q2 is averaged by the LC filter made up of L1 and C1 generating a DC output voltage across R_{LOAD}. The DC voltage across R_{Load} is approximately equal to Vin times the duty cycle of the periodic PWM signal. In the process of generating this output voltage, an additional voltage is generated which is used by the circuitry generating Vout. When Q2 is ON, C2 is charged to Vin through D1 leaving the top of C2 positive with respect to the bottom of C2. At the start of the next PWM cycle, Q2 is turned OFF and Q1 is turned ON placing the input voltage in series with C2 through Q1. During this period C3 is now charged through D2 to approximately 2*Vin.

In FIG. 3E the voltage across C3 is used to by the driver U1 to provide the gate drive voltage for Q1 that is approximately 2*Vin above ground.

FIG. 3F provides a source referenced V_Gate_Bias for Q1 that is approximately equal to twice Vin. This circuit works well when Vin is around 5V. U1 uses the PWM signal to turn Q1 ON and OFF. Q1 is ON when the PWM signal is high and it is OFF when the PWM signal is low. The PWM signal is referenced to ground. In FIGS. 3A, 3B and 3C, U1 is referenced to ground so no level shift is needed. However, in FIG. 3D, U1 is referenced to the source of Q1. A level shift circuit 26 is used to take the PWM signal, which is referenced to ground, and generate a new signal that is equivalent to the PWM signal but is now referenced to the same point to which U1 is referenced. Since U1 is referenced to the source of Q1, U1 gets its supply voltage from the voltage across C4. Q1 is called the high side switch and the voltage across C4 would be called the high bias. Q2 is referenced to ground and is called the low side switch. U2 is used to turn Q2 ON and OFF out of phase with Q1 as commanded by the PWM signal. U2 is referenced to ground and gets its supply voltage across C3. Since the voltage across C3 powers the gate drive circuit, U2, for the low side switch, it is called the low bias.

All of these circuits have been used and all of them provide valid approaches for generating a bias voltage for the MOSFET devices. More specifically, all of the circuits in FIGS. 3B though 3F provide gate drive bias voltages that are proportional to Vin or are proportional to some fixed voltage source. In the latter case this fixed source needs to be generated somewhere else in the system.

FIG. 4 is a block diagram of a prior art implementation of a buck regulator DC/DC converter employing an auxiliary regulator 28 and a buck regulator power section 30. Components in FIG. 4 which perform the same or similar functions to those in FIGS. 3A to 3F have been given the same reference characters or numbers.

The auxiliary regulator 28 is powered from the input source to generate a voltage to be used by the buck regulator control circuitry 32.

The buck regulator control circuitry 32 represents the circuit that generates the gates drive signal(s) and, in FIGS. 3A to 3F, would encompass all of the circuitry from the PWM signal through U1 and U2. Vboot is a DC voltage referenced to the source of the high side switch and is used by the buck regulator control circuitry 32 to provide gate drive for the high side switch Q1. Gate(H) is the actual signal used to turn the high side switch Q1 ON and OFF. Gate(L) is the actual signal used to turn the low side switch Q2 ON and OFF. PP represents the power pulse which is the input voltage modulated by the PWM signal and is fed back to the buck regulator control circuitry 32 to provide a signal proportional to output current.

FIGS. 5A through FIG. 5E depict common alternatives for the auxiliary regulator block in FIG. 4. Components in FIGS. 5A through 5E performing the same or similar functions to those in FIGS. 3A to 3F have been given the same reference characters or numbers.

FIG. 5A simply passes Vin to Vaux. This works but typically narrows the operating range of the buck regulator to a very specific input voltage.

FIG. 5B is a simple linear regulator employing a signal transistor 34, a resistor 36 and a zener diode 38. The circuit of FIG. 5B can be used to generate an auxiliary voltage when Vin is too large for the control circuit and gate drive. If efficiency is a concern, the small buck regulator, as shown in FIG. 5C, will work as well. The disadvantage of the circuits in FIGS. 5B and 5C is that they can only produce auxiliary voltages less than Vin.

Referring to FIG. 5D, a simple pulse transformer and rectifier circuit employing an oscillator 42, MOSFET 44, transformer 46, diode 48 and capacitor 52 can be used to scale Vin by the turns ratio of the transformer 46. This circuit provides no regulation and produces an auxiliary voltage that is strictly proportional to Vin. The circuit in FIG. 5D could be followed by the circuit in FIG. 5B but this circuit would suffer from low efficiency.

A boost regulator employing a MOSFET 54, a control circuit 56, an inductor 58, a diode 60 and a capacitor 62 can also be used for an auxiliary supply as shown in FIG. 5E. This circuit works only when an auxiliary voltage higher than Vin is desired.

As should be appreciated from the foregoing, if it is desired to construct a single buck regulator power supply that will produce one or more output voltages from a single input voltage, the design of this buck regulator must include an auxiliary voltage regulator to generate operating voltages for the gate drive circuitry and control circuitry. The desired input operating range for such a regulator could be from 3V to 15V allowing a single part number to be applied in a wide range of applications. This input range would allow operation from standard 3.3V, 5V, or 12V supply voltages, which are very common. It would also allow operation from a 12V battery system. The control and gate drive circuitry for a typical buck regulator design usually requires a fixed operating voltage in the range of 5 to 12V. If the input voltage range falls above and below the range of desired operating voltages then the auxiliary voltage regulate would need to be capable of both boosting (step up) or bucking (step down) the input voltage in order to generate an operating voltage for the internal circuitry of the buck regulator.

It can also be shown that different MOSFETs will have an optimum gate drive voltage as a function of output load, input voltage, and available gate drive current. In some cases this optimum gate drive voltage will be the same over all operating ranges of the converter. In other cases it may be desirable to tailor this gate drive voltage at different operating voltages. FIG. 6 shows the gate charge Vs. gate to source voltage characteristics of a typical MOSFET. FIG. 7 shows how RDSon changes verse gate to source voltage for the same device. Depending on the operating parameters of the converter there is often an optimum fixed gate drive voltage to operate at. In some situations improvements in efficiency can be achieved by lowering the gate drive voltage at higher input voltages. FIG. 8 shows the total MOSFET power losses at various gate drive voltages. In this example it can be seen that a slight decrease in power loss occurs at higher Vin if the gate drive voltage is lowered.

### SUMMARY OF THE INVENTION

It is an object of the present invention to provide a buck regulator DC/DC converter which may be operated over a wide range of voltages.

This and other objects are achieved in accordance with certain aspects of the invention by a DC/DC converter comprising a switched mode power supply employing gate driven switching devices; and a flyback converter for providing a gate drive voltage to the gate driven switching devices.

In accordance with another aspect of the invention, a flyback converter is provided comprising a flyback transformer having a primary winding and a secondary winding, a first switching device for providing a voltage to the primary winding of the flyback transformer, a switching circuit arranged to cyclically turn the first switching device ON and OFF to cyclically apply the voltage to the primary of the transformer and a voltage control circuit for sensing the voltage of the secondary winding of the flyback transformer, comparing the voltage of the secondary winding to a reference voltage, and generating an error signal to control the magnitude of the voltage applied to the primary winding of the flyback transformer.

In accordance with still another aspect of the invention, a user programmable under voltage lockout circuit is provided for disabling the turning ON of the flyback converter if an input voltage is lower than a predetermined value.

In accordance with another aspect of the invention, a multi-phase buck regulator DC/DC converter is provided comprising a plurality of buck regulator power sections, the outputs of which are connected in parallel and connected to an output load circuit and a controller for providing pulse width modulation (PWM) signals to each power section, the PWM signals to each power section being shifted by 360°/n from each other, where n is the number of buck regulator power sections.

Other features and advantages of the present invention will become apparent from the following description of the invention which refers to the accompanying drawings.

### BRIEF DESCRIPTION OF THE DRAWING(S)

FIGS. 1A and 1B are block diagrams of basic prior art implementations of buck regulators;

FIG. 2 shows the waveforms as the buck regulator of FIG. 1B;

FIGS. 3A-3F are block diagrams of various prior art methods of generating gate drive voltages;

FIG. 4 is a block diagram of typical prior art implementation of a buck regulator power supply;

FIGS. 5A-5D show prior art implementations of auxiliary regulators;

FIG. 6 is a graph showing typical gate charge Vs. gate to source voltage characteristics;

FIG. 7 is a graph showing typical ON resistance Vs. gate to source voltage characteristics;

FIG. 8 is a graph showing typical MOSFET power loss curves at various gate voltages;

FIG. 9 is a block diagram of a buck regulator DC/DC converter in accordance with the present invention;

FIG. 10 is a schematic of a flyback converter used as an auxiliary regulator in accordance with the invention;

FIG. 11 is a graph showing the flux characteristics in the inductor L1 of the flyback converter of FIG. 10.

FIG. 12 is a schematic of a circuit in accordance with the invention for modifying the output voltage of the auxiliary regulator of FIG. 10; and

FIG. 13 is a block diagram of a multi-phase buck regulator DC/DC converter employing the buck regulator DC/DC converter of FIG. 9 and the flyback converter of FIG. 10 in accordance with certain features of the invention.

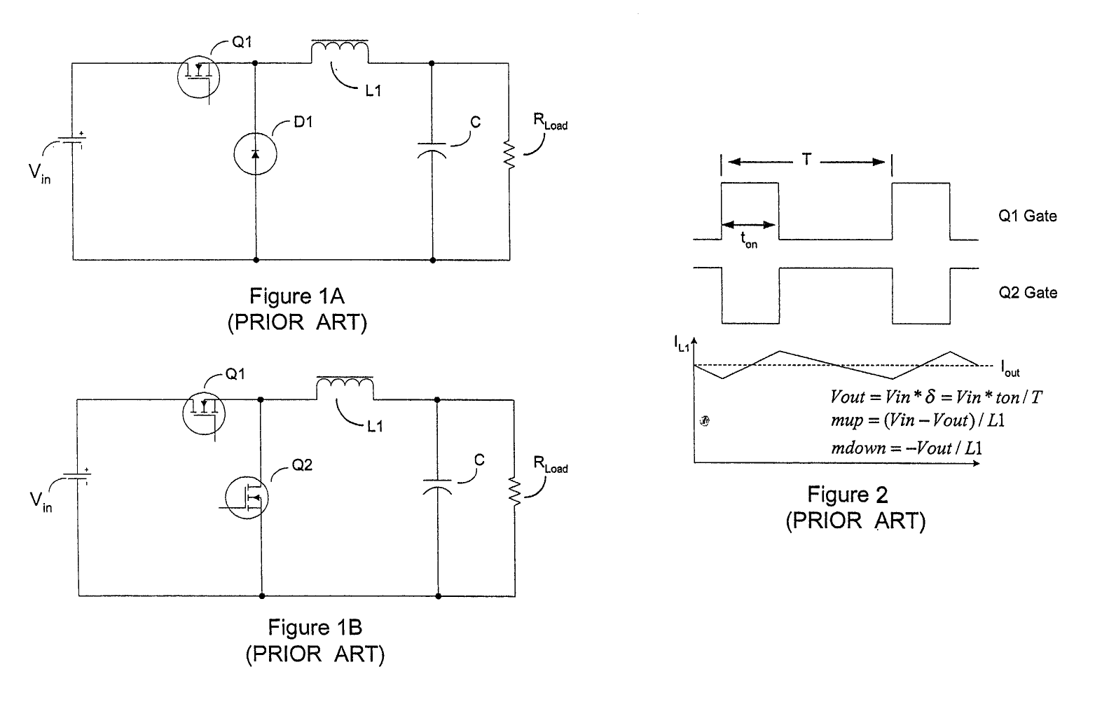

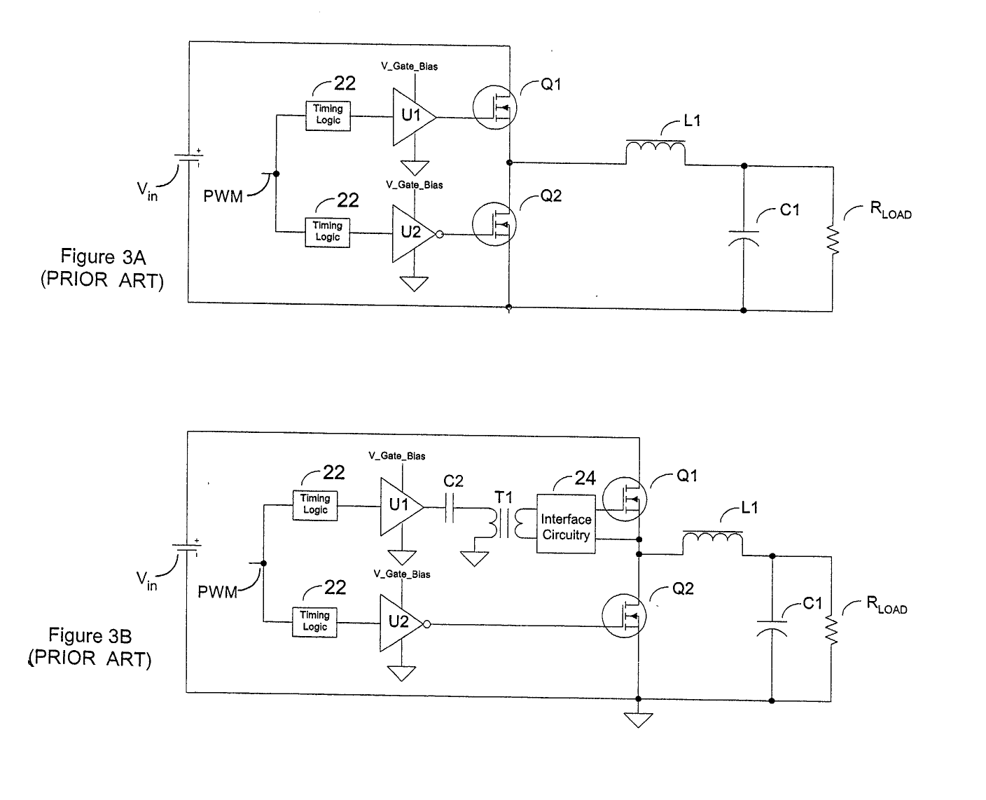

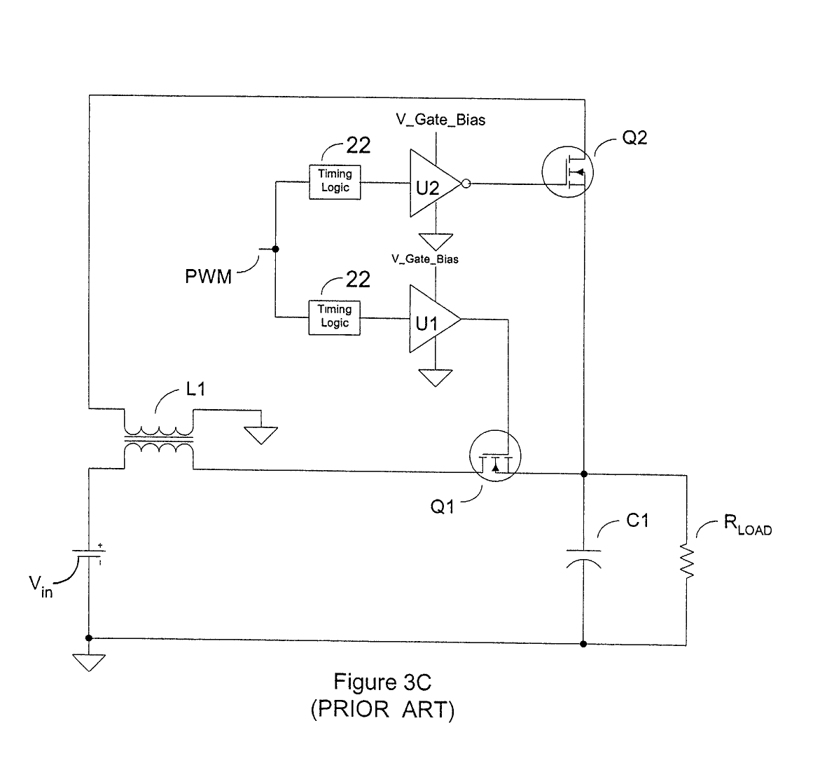

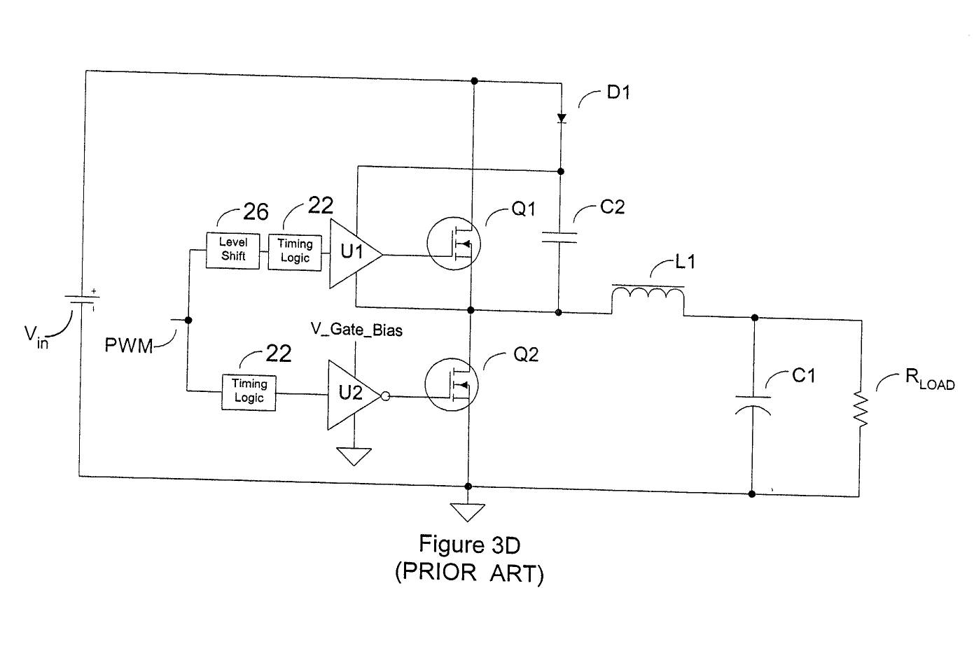

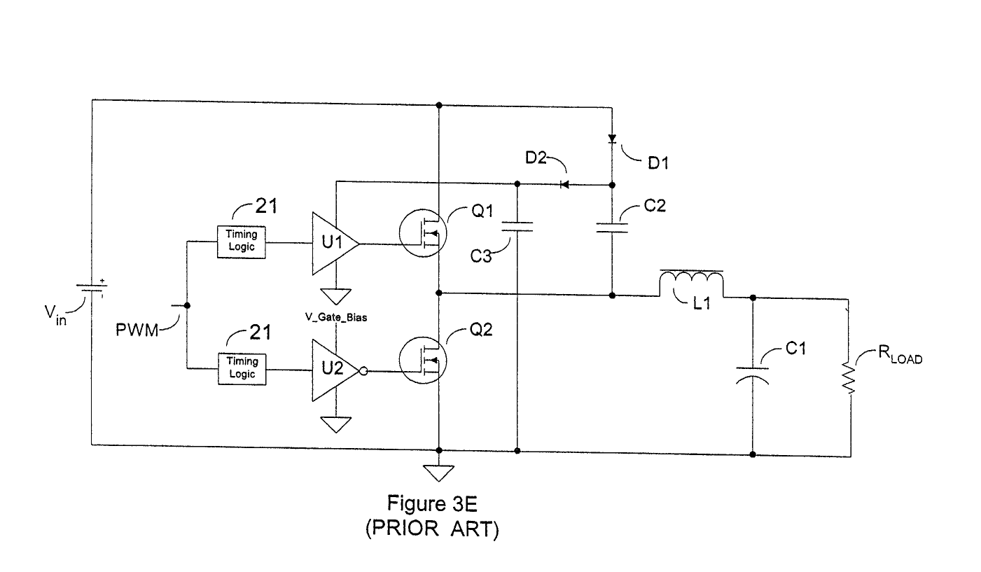

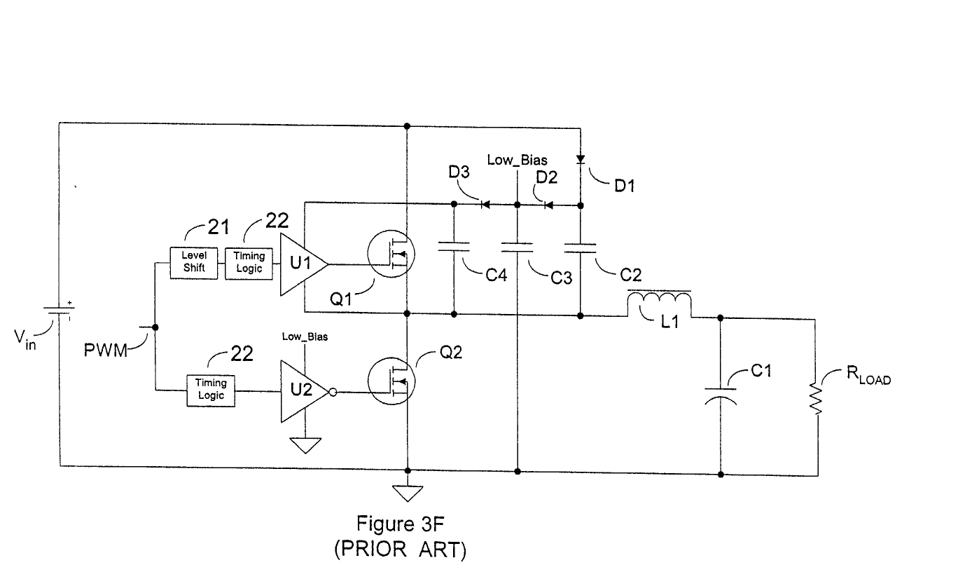

### DETAILED DESCRIPTION OF THE PREFERRED EMBODIMENT(S)

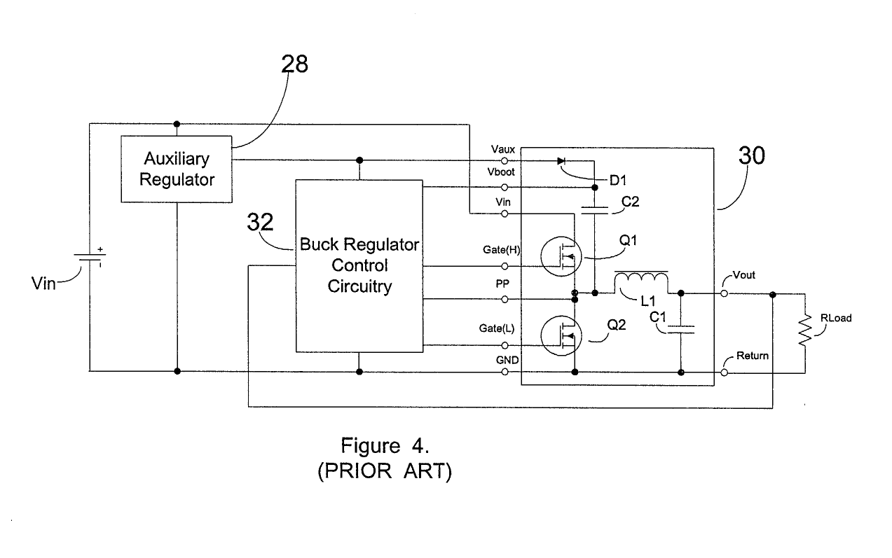

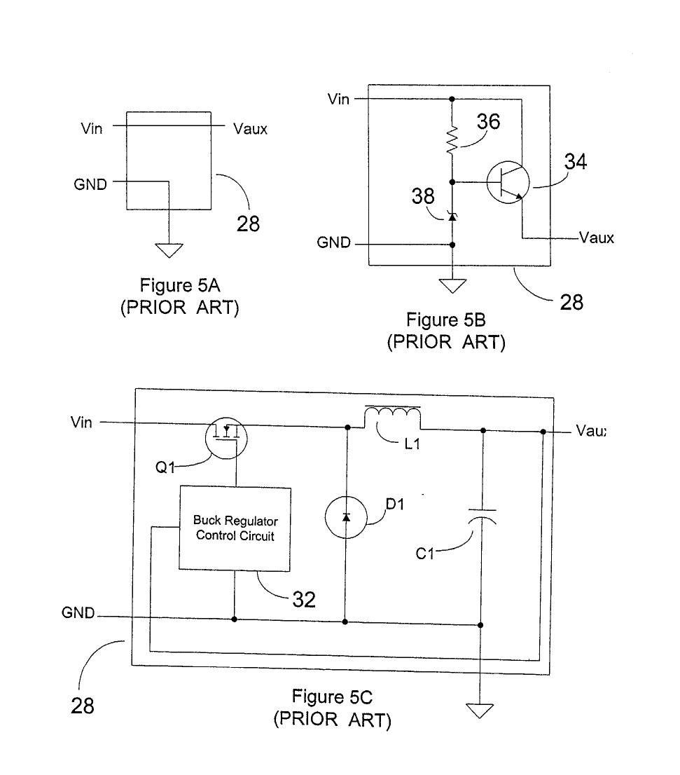

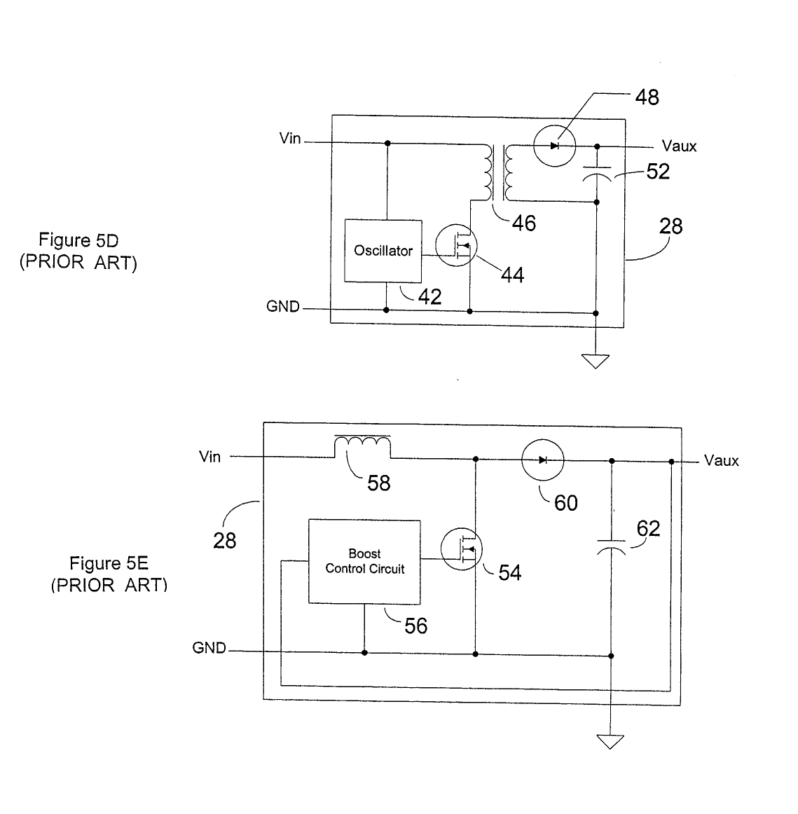

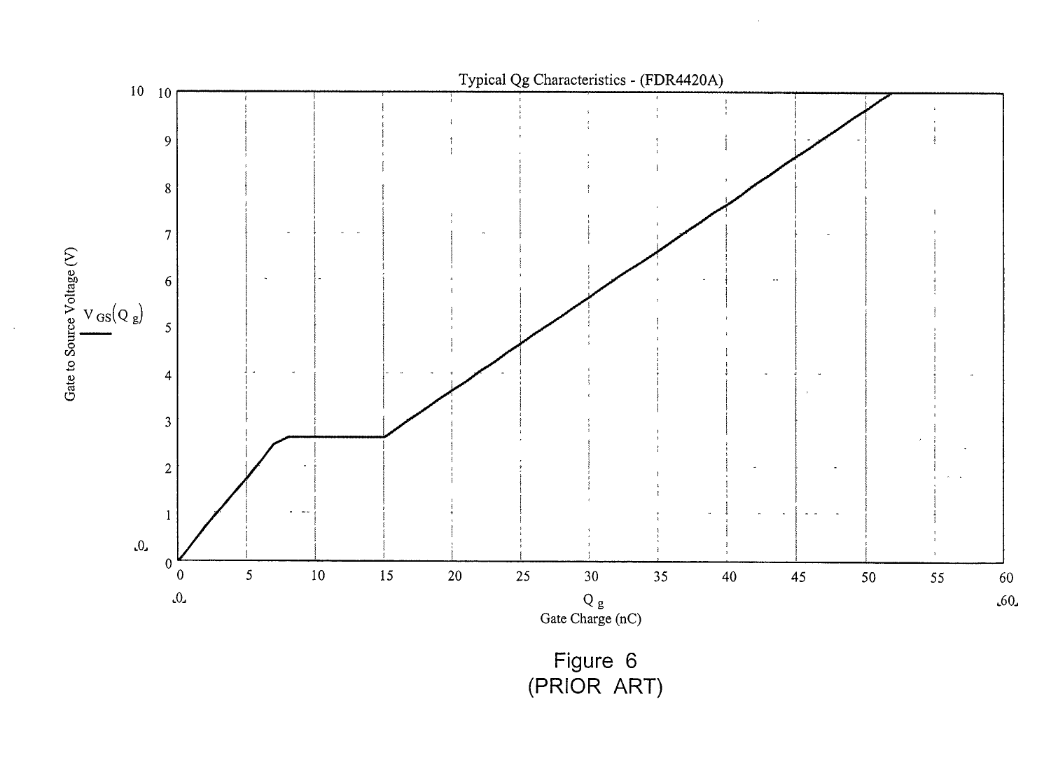

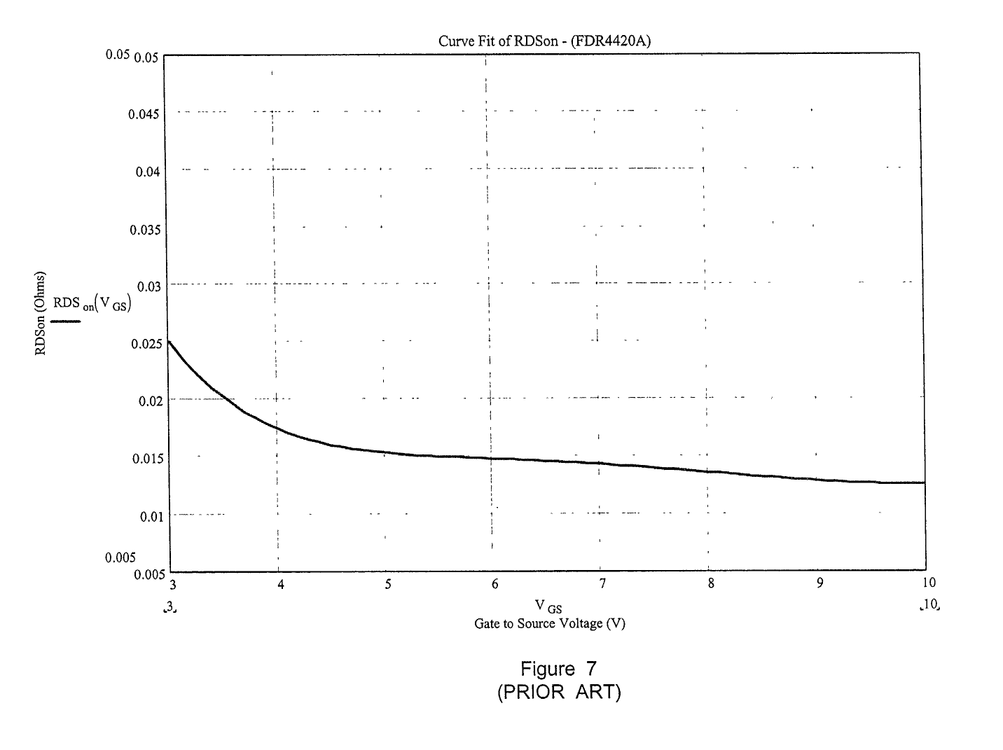

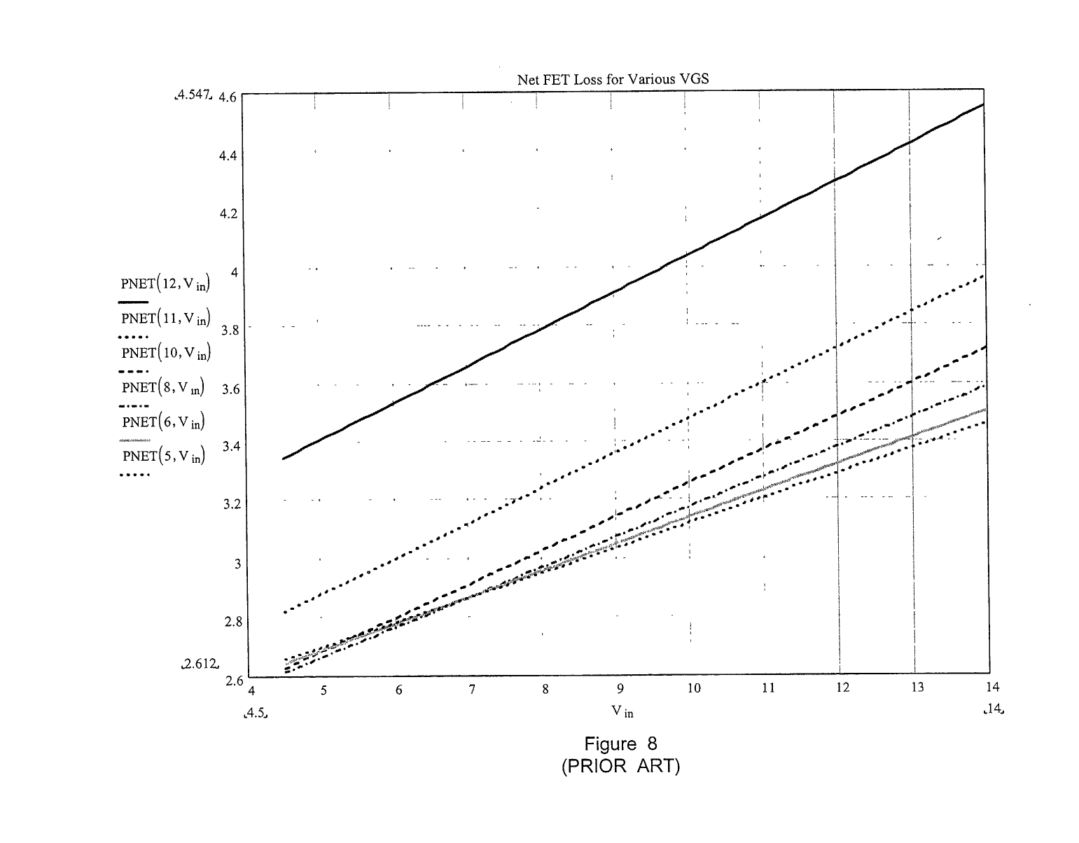

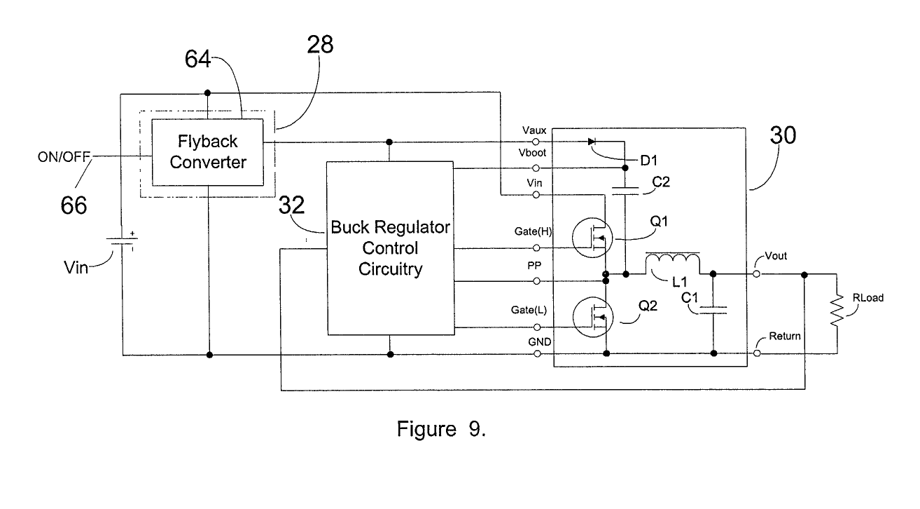

Referring now to the drawings, in which components performing the same or similar functions are designated with the same reference characteristics or numbers, and, in particular, to FIG. 9, there is shown a block diagram of a buck regulator DC/DC converter which, in accordance with the present invention, employs a flyback converter 64 as the auxiliary regulator 28; in all other respects, the circuit of FIG. 9 is the same as the circuit of FIG. 4.

The flyback converter 64 provides a wide range of auxiliary voltages Vaux allowing the regulator to operate over a wide input voltage range. More specifically, the flyback converter 64 has the capability to either boost or buck the input voltage Vin and thus can provide a fixed auxiliary voltage Vaux that is either greater than or less than the input voltage Vn. The flyback converter 64 also has a pin 66 enabling remote ON/OFF control of the flyback converter 64. More specifically, when the pin 66 is connected to ground, the flyback converter 64 is turned OFF, thereby removing operating voltage from the buck regulators control circuitry 32 and turning it OFF. This same input pin 66 can also be used to adjust the under voltage lockout, (i.e., the low input voltage where the converter shuts OFF), by adding an external resistor from the pin 66 to ground.

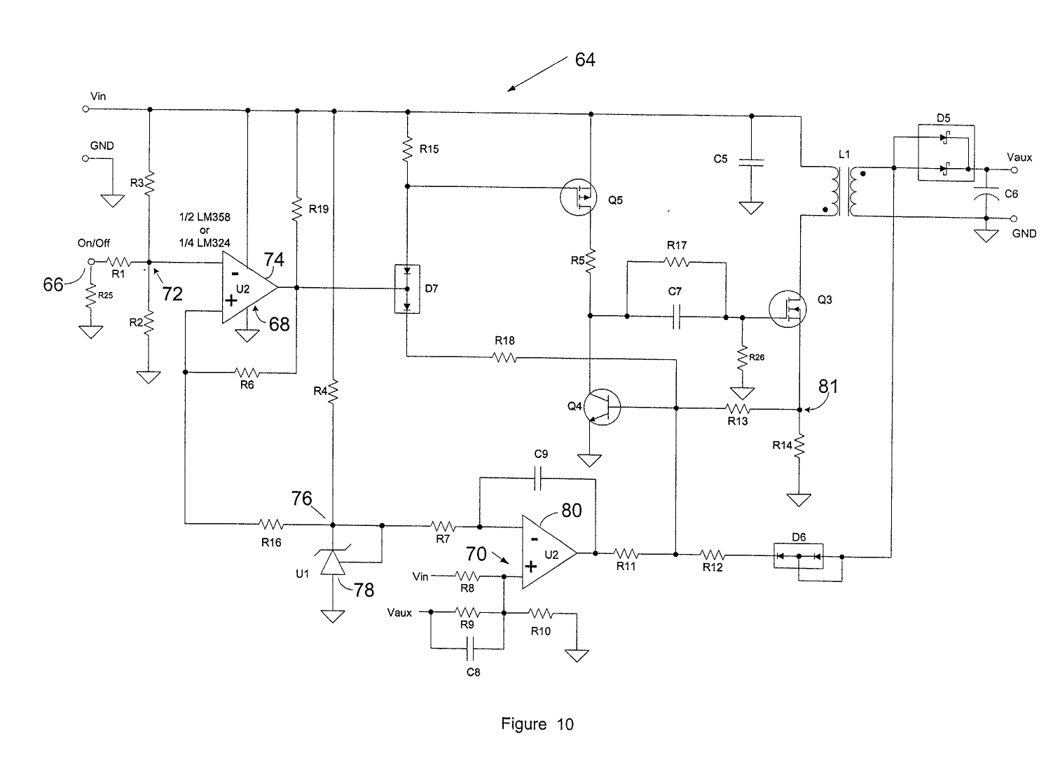

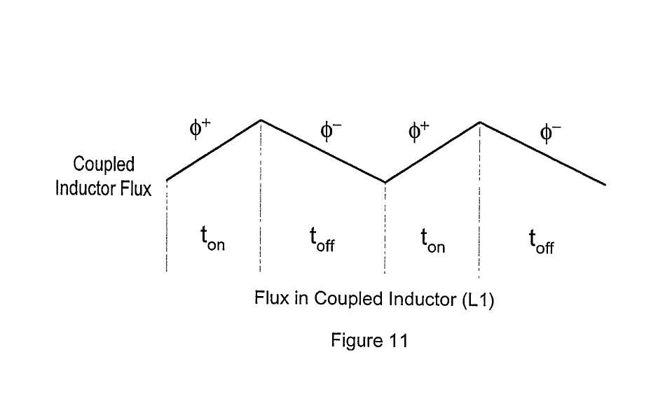

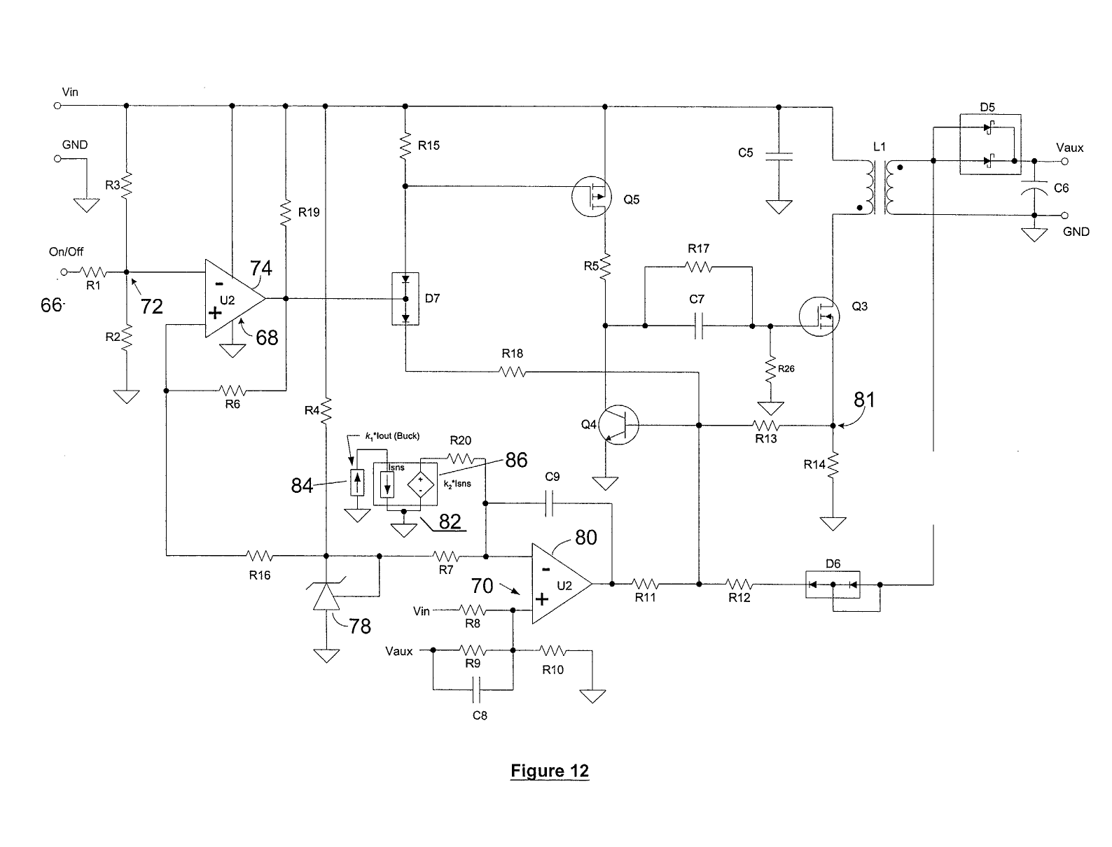

The specific design of the flyback converter 64 is shown in FIG. 10. The topology is a self-oscillating flyback regulator that runs slightly discontinuous due to the storage time of Q4. The ON time of the main switch Q3 is controlled by comparator and error amplifiers 68 and 70, respectively, to limit the energy stored in L1 during each switching cycle. The energy stored in L1 during the time that Q3 is ON is transferred to the load through D5 when Q3 is turned OFF. FIG. 11 shows the flux characteristics of the inductor L1.

Continuous Vs. discontinuous relates to whether or not the inductor currents are reset to 0 at the start of each new switching cycle. Just discontinuous is the mode where a converter is operated right at the boundary where if each switching cycle started at t=0 at t=0ₘᵢₙᵤₛ, the mode would clearly be discontinuous and at t=0ₚₗᵤₛ, the mode would clearly be continuous and at t=0, the mode would be right at the boundary condition.

Definition of “Just Discontinous Mode” (JDCM):

T=tₒₙ+t_{off}t_{off}=t_{flyback}

Since all of the energy stored in L1 during tₒₙ is reset during t_{off} the JDCM topology has the same small signal transfer function as the discontinuous mode flyback. Since there is no dead time and thus operates at the discontinuous/continuous boundary the large signal transfer functions for both apply since they converge at that point.

$$\begin{matrix}{φ}_{p} = {φ}_{n} & & & δ = \frac{{V}_{o u t}}{{V}_{i n}} \cdot N \cdot ( 1 - δ ) \\ {V}_{i n} \cdot {t}_{o n} = N \cdot {V}_{o u t} \cdot {t}_{off} & & & \\ \frac{{V}_{o u t}}{{V}_{i n}} = \frac{{t}_{o n}}{{t}_{off}} \cdot \frac{1}{N} = \frac{{t}_{o n}}{T - {t}_{o n}} \cdot \frac{1}{N} & & & δ + N \cdot \frac{{V}_{o u t}}{{V}_{i n}} \cdot δ = \frac{{V}_{o u t}}{{V}_{i n}} . \\ \frac{{V}_{o u t}}{{V}_{i n}} = \frac{\frac{{t}_{o n}}{T}}{( 1 - \frac{{t}_{o n}}{T} )} \cdot \frac{1}{N} & & & δ = \frac{\frac{{V}_{o u t}}{{V}_{i n}} \cdot N}{1 + N \cdot \frac{{V}_{o u t}}{{V}_{i n}}} \\ \frac{{t}_{o n}}{T} = δ & & & \\ \frac{{V}_{o u t}}{{V}_{i n}} = \frac{1}{N} \frac{δ}{1 - δ} & & & δ = \frac{N \cdot {V}_{o u t}}{{V}_{i n} + N \cdot {V}_{o u t}}\end{matrix}$$

Definition of “Almost Just Dis-Continous Mode” (AJDCM)

T=tₒₙ+t_{off}+t_{dead}

Summary of JDCM Equations

$$\frac{{V}_{o u t}}{{V}_{i n}} = \frac{1}{N} \cdot \frac{δ}{1 - δ} \qquad δ = \frac{N \cdot {V}_{o u t}}{{V}_{i n} + N \cdot {V}_{o u t}}$$

Summary of DCM Equations

$$\frac{{V}_{o u t}}{{V}_{i n}} = δ \cdot \sqrt{\frac{{R}_{o u t} \cdot η}{2 \cdot {L}_{p r i m a r y} \cdot {F}_{s w}}}$$

$${F}_{s w} = \frac{η \cdot {V}_{i n}^{2} \cdot {δ}^{2}}{2 \cdot {L}_{p r i m a r y} \cdot {P}_{o u t}}$$

$${L}_{p r i m a r y} = \frac{η \cdot {V}_{i n}^{2} \cdot {δ}^{2}}{2 \cdot {F}_{s w} \cdot {P}_{o u t}}$$

$${I}_{s e c o n d a r y \_ p k} = 2 \cdot \frac{{I}_{o u t}}{1 - δ}$$

The topology of the flyback converter 64 does not have perfect “JDCM” operation. Unlike true “JDCM” operation the start of the next switching cycle does not start at the end of the flyback. Accordingly, this mode is defined as the “Almost Just Dis-Continuous Mode” or “AJDCM”. Like a true “JDCM”, topology the operating frequency of the “AJDCM” topology is variable with line and load.

In this topology, the gate of the primary switching FET Q5 is not driven with a hard driver. Since the current of the inductor L1 is zero at tₒₙ, there is no need to turn ON the FET Q5 with a sharp transition. However, the switching FET Q5 is turned OFF hard by pulling the gate to ground by a transistor Q4 coupled to the gate of Q3 through the combination of a resistor R17 and a capacitor C7. A sharp turnoff is desired since at turn OFF the peak switch current is being terminated.

Two elements of the gate drive circuitry result in a delay in turning on the switching FET after the flyback period: 1) The storage time for a typical small signal transistor Q4, like a 2N4401, is in the order of 250 nS. To keep cost low and reduce parts count, no additional circuitry is provided to sweep the storage charge when Q4 is turned OFF. In addition, the feedback bias circuitry, i.e., the output of the amplifier 80 delivered to the base of Q4 through the resistor R11 limits how far the base of Q4 is pulled towards ground. As a result, the actual storage time in this application could be as high as 500 ns. The storage time can be reduced significantly by lowering the base drive current of Q4 during the flyback period. This may be achieved by increasing the value of R12. In doing so one must be careful to allow enough drive to quickly turn the transistor Q4 ON at the start of the flyback interval. The fall time also needs to be accounted for which for a small signal device, is around 100 ns. Depending on the value of R12 the turn OFF delay for Q4 can be in the range of 350 ns to 1 us. 2) When Q4 is turned OFF, the start of the next switching cycle commences only after the gate of the switching transistor Q3 reaches its turn ON threshold. Since this device is turned ON through a resistor R5, the time it takes to charge the gate of Q3 needs to be accounted for.

The comparator amplifier 68, which includes an operational amplifier 74, is used to provide an under voltage lockout feature and to enable remote ON/OFF control. The node 72, at a junction between resistors R2 and R3 which function as a voltage diode, represents a voltage that is proportional to Vin and is applied to the negative input of the amplifier 74. A reference voltage generated at a node 76 by an adjustable reference 78 connected to Vin through a resistor R18 is applied to the positive input of the amplifier 74. When Vin is high enough such that the node 12 is higher than the reference voltage at the node 6b, the output of the amplifier 74 will go LOW turning ON the p-channel MOSFET Q5 and, thus, enabling gate drive voltage to Q3. If the ON/OFF pin 66 is grounded, R1 is sized so that the voltage at the node 12 will never get above the reference voltage at node 76 and, thus, Q5 and Q3 will never turn ON. When the On/Off pin 66 is floating, the flyback converter 64 will start at a voltage determined by the voltage divider made up of R2 and R3. If it is desired to increase this voltage, a resistor R25 may be connected from the On/Off pin 66 to ground. This will modify the R2-R3 voltage divider causing the under voltage lock out point to increase. The under voltage lock out point can be programmed by the same pin 66 used to remotely turn the converter ON and OFF.

R19 is used to pull up the output of the amplifier 74 during an under voltage lockout condition, i.e., when Vin is below the operating voltage. The output of the amplifier 74 is at Vᵢₙ until the start of operation.

When in the under voltage lock out condition, Q4 is also held on by D7 and R18. This assures a clean start pulse when the flyback converter 64 is allowed to start up by keeping C7 discharged. R17 is sized so that while Q4 is ON, any leakage currents in the circuit will not allow the gate voltage of Q3 to reach its threshold. Q5 is held OFF during this period to limit the power loss during turn OFF by removing the voltage source to R5. Turning on Q4 provides a path for leakage current from the drain to the gate of Q3. R26 can be used to shunt this leakage current to ground preventing un-intended turn on of Q3. This would be useful when Vin is below the operating limit for the amplifier 74 since in that condition the amplifier 74 would not be able to turn on Q4 through D7 and R18.

When the flyback converter 64 starts up, Q5 is turned ON and Q4 is turned OFF. The gate of Q3 goes high through R5 and C7 turning Q3 ON. When Q3 is ON, the current in L1 will ramp up until the voltage at a node 81 (i.e., the junction between resistors R13 and R14) is high enough to turn Q4 ON. When Q4 is turned ON, Q3 will turn OFF through C7 and L1 will “flyback” coupling the stored energy to the output. During the “flyback” period the secondary of L1 will be high with respect to ground holding Q4 ON through D6 and R12. Q4 will be held ON during the entire “flyback” period. At the end of the “flyback” period, the field (or flux) in the inductor L1 will collapse and the windings will fall to zero volts. At this time there is no current in the inductor L1 and Q3 is OFF so the voltage at node (3) is zero. There is no voltage across the secondary so D6 and R12 no longer provide a current path to keep Q4 ON. Once the charge in Q4's base is reset, it will turn OFF and a new switching cycle will commence.

The output voltage Vaux is controlled via the error amplifier 72 which includes an operational amplifier 80. The error amplifier 72 compares Vaux to the reference at the node 76 and generates an error voltage. This error voltage is summed to Q4's base through R11. This error voltage essentially has a pre-biasing effect impacting how the voltage at the node 81 turns Q4 ON. The current through R11 controls how far the node 81 needs to ramp during each switching cycle in order to turn Q4 ON in order to terminate the switching cycle. This controls the amount of energy stored in L1 during each switching cycle to the value needed to maintain a fixed output voltage as programmed by the reference at the node 76. The combination of the resistor R9 and the capacitor C9 and the capacitor C8 provide feedback compensation and assure stable operation.

R10 makes up a voltage divider with R9. It is used to set the exact voltage of Vaux. R7 is used as part of a compensation network for the amplifier 80 in combination with C9. R13 is used to limit the current delivered to Q4's base as a result of the voltage drop across R14. R14 is used to detect the current flowing through L1 and Q3. The voltage drop across R14 is proportional to this current. R15 is used to prevent Q15's drain to gate leakage current from turning on Q15 if Vin is below the operating range for the amplifier 74. R16 is used to deliver the under voltage lockout reference to the amplifier marked 74. R6 in combination with R16 generates hysteresis for the under voltage lockout circuitry.

The output voltage can be scaled down as Vin increases by providing a resistor R8. If R8 is provided, the feedback voltage will be modified by Vin lowering the output voltage, Vaux, at higher input voltages.

Advantageously, the operational amplifiers 72 and 80 may be ½ LM358 or ¼ LM324, manufactured by National Semiconductor and the adjustable reference 78 may be a SC431CSK-0.5 manufactured by Semtec.

Referring to FIG. 12, there is shown a modification of the circuit of FIG. 10, which incorporates an auxiliary voltage modification circuit 82. The auxiliary modification circuit 82 generates a voltage proportional to the output current of the buck regulator section 30 (FIG. 9) and is used by the flyback converter 64 to modify the auxiliary voltage Vaux used to provide the gate drive voltage and, thus, controls the gate voltage of the buck regulator switching devices Q1 and Q2 (FIG. 9) as a function of the output current of the buck regulator section 30. With the exception of the circuit 82, the circuitry in FIG. 12 is the same as that in FIG. 10.

The circuit 82 includes a current source 84 that is derived from the output current of the buck regulator section 30 (FIG. 9). This current source 84 provides a current which varies in proportion to the buck regulator output current by a constant K1. The buck regulator output current is the current flowing through the load R_{Load} (FIG.9) connected between Vout and the return of the buck regulator section 30. The current source 84 is used as the input to a current controlled voltage source 86. The current control voltage source 86 will output a voltage that is proportional to input current scaled by K2. Isns is a signal representative of the output current of the buck regulator and may, for example, be generated by sensing the voltage drop across a resistive element in series with the output current path.

In the absence of any other control, the voltage at the negative terminal of the amplifier 80 is set by the reference node 76 and is used to set the voltage Vaux to a fixed value. With the addition of the auxiliary modification circuit 82, the negative input-pin of the amplifier 80 is now modified in proportion to the buck regulator output current. This modification of the voltage reference is such that a higher buck regulator output current results in a higher reference and thus a higher Vaux voltage.

The resistor R20 in FIG. 12 is used to modify the reference of the flyback converter 64 such that at higher buck regulator output currents a lower auxiliary voltage Vaux is generated. R20 modifies the reference on the negative input to the amplifier 80 by acting as a voltage divider with R7. By superposition, the voltage at the negative input to the amplifier 80 is a function of the voltage on the cathode of the adjustable reference 78 and the output of the current controlled voltage source 86.

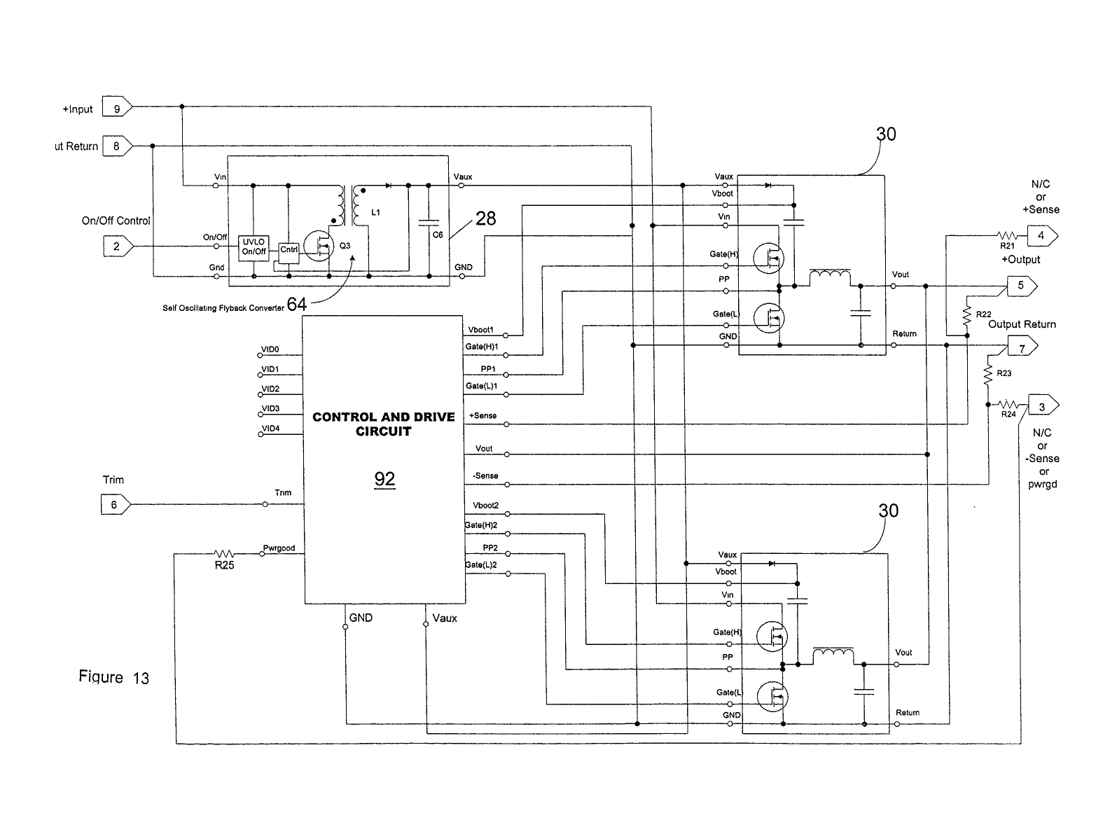

Referring now to FIG. 13, there is shown a block diagram of a 2-Phase buck regulator DC/DC converter in accordance with the present invention. In this circuit, two synchronous buck regulator power sections 30 are controlled by a single control circuit 92. The control circuit 92 generates PWM signals to regulate the output voltage to a fixed value. Each power section 30 is controlled 180° out of phase with the other.

Controlling the power sections 180° out of phase results in less output noise. This can be understood by referring to FIG. 2, in which the inductor current timing waveform has both an up slope and a down slope. If two sections are connected in parallel and controlled 180° out of phase, one section's up slope will occur during the other section's down slope. With two sections in parallel, the two inductor currents add together to supply the load current. If one section is ramping up (the up slope period) while the other section is ramping down (the down slope period), the AC portion of the inductor currents will tend to cancel each other out resulting in a purer DC output.

Any number of power stages 30 from 1 to N may be used where the control circuit 92 regulates the output voltage by means of pulse width modulation and where the control circuit 92 delivers PWM signals to each power section that are shifted by 360°/N from each other where N is the total number of power sections. Additionally, rather than the power stages being connected in parallel and out of phase with each other, they may be arranged so that they are in phase and connected in parallel.

Although a single power stage 30 may be used in accordance with the invention, multiple sections 30 have the following advantages: 1) The power handling limitations of readily available components employed to make up the power section 30 limit the maximum available output current for a single section 30. Placing multiple sections 30 in parallel allows higher output currents to be achieved from readily available components; 2) At higher output currents the power loss is spread out amongst more components resulting in a more effective cooling area and, thus, less heat generated as a function of power loss; and 3) multiple sections result in a purer DC output.

In accordance with the invention, the auxiliary regulator 28 is a flyback converter 64, such as that disclosed in FIGS. 10 and 12. This flyback converter 64 generates internal supply voltages for the control and gate drive circuitry and has the capability to either boost or buck the input voltage Vin and, thus, can provide a fixed auxiliary voltage that is either greater than or less than the input voltage. The remote ON/OFF function of the flyback converter 64 when connected to ground turns OFF the flyback converter 64 removing operating voltage from the buck regulators control circuit 92, thus, turning it OFF. This same input can also be used to adjust the under voltage lockout, (i.e., the low input voltage where the converter shuts OFF), by adding an external resistor from this pin to ground.

In FIG. 13, VID0-VID4 are the are called voltage ID's. They are binary signals used to set the output voltage value. Trim is an analog signal which can be used to set the output voltage externally. Pwrgood is an output that is used to indicate that the output of the power supply is at its set value. Vboot1 and Vboot2 are the DC voltages used by the high side gate drive circuitry for each power section. Gate(H)1 and Gate(H)2 are the high side gate drive signals for each power section. PP1 and PP2 are the power pulses for each power section. Gate(L)1 and Gate(L)2 are the gate drive signals for the low side switches in each power section. +Sense and −Sense are the feedback points for the control circuitry that adjusts the PWM signal to control the output voltage. Vaux is the DC voltage used by the control circuitry. The under voltage lockout is with respect to the +input. It inhibits operation of the circuitry when the input voltage is below the set point. The control circuit 92 may be a commercial unit, such as an Intersil part number ISL6553.

R21-R24 are used to provide optional feature sets depending on unique combinations of which of these resistors are populated or left unused. For example populating R23=51.1 ohms, R24=0 ohms, R21=51.1 ohms and R22=0 ohms, while R25 is left empty will enable a +Sense and −Sense feature on pins 3 and 5. Another option would be populating R25=0 ohms, R23=0 ohms, R21=0 ohms and leaving R24 and R22 empty. This would make pin 3 a power good signal while leaving pin 5 unused.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A DC/DC converter comprising:
a switched mode power supply employing gate driven switching devices; and
a flyback converter for providing gate drive voltages to the gate driven switching devices.

2. A DC/DC converter according to claim 1, wherein the flyback converter is self-oscillating.

3. A DC/DC converter according to claim 1, wherein the flyback converter increases or decreases an input voltage to provide gate driven voltages to the gate driven switching devices.

4. A DC/DC converter according to claim 1, wherein the switched mode power supply is a buck regulator.

5. A DC/DC converter according to claim 4, wherein the flyback converter comprises:
a flyback transformer having a primary winding and a secondary winding;
a first switching device for providing a primary voltage to the primary winding of the flyback transformer;
a switching circuit arranged to cyclically turn the first switching device ON and OFF to cyclically apply the primary voltage to the primary of the transformer; and
a voltage control circuit for sensing a secondary voltage at the secondary winding of the flyback transformer, comparing the secondary voltage of the secondary winding to a reference voltage, and generating an error signal to control the magnitude of the primary voltage applied to the primary winding of the flyback transformer.

6. A DC/DC converter according to claim 5, wherein the flyback converter further comprises means for receiving an input voltage, and an under voltage lockout circuit for disabling the switching circuit from turning the first switching device ON and OFF if the input voltage is lower than a predetermined value.

7. A DC/DC converter according to claim 6, wherein the flyback converter further includes means for changing the predetermined value.

8. A DC/DC converter according to claim 5, wherein the flyback converter further includes means for generating a feedback voltage proportional to the output current of the buck regulator and for inputting this feedback voltage control circuit to change the magnitude of the reference voltage.

9. A DC/DC converter according to claim 6, wherein the switching circuit comprises second and third switching devices, the second switching device being arranged to turn the first switching device ON and OFF and the third switching device being arranged to turn the second switching device ON and OFF.

10. A DC/DC converter according to claim 6, wherein the third switching device is connected to the under voltage lockout circuit such that the under voltage lockout circuit turns ON the third switching device if the input voltage is above the predetermined value and turns OFF the third switching device if the input voltage is below the predetermined value.

11. A DC/DC converter according to claim 6, wherein the under voltage lockout circuit comprises an operational amplifier and the input voltage is connected to one of the inputs of the operational amplifier through a voltage divider.

12. A DC/DC converter according to claim 6, wherein the under voltage lockout circuit includes an ON/OFF terminal connected to said one input of the operational amplifier through a resistor.

13. A DC/DC converter according to claim 12, wherein the resistor is connected from the ON/OFF terminal to ground to change.

14. A DC/DC converter according to claim 19, wherein the first and third switching devices are MOSFETs.

15. A DC/DC converter according to claim 14, wherein the second transistor is a bipolar transistor.

16. A DC/DC converter according to claim 14, wherein a resistor is provided for sensing current through the primary winding of the flyback transformer and the resistor is connected to the bipolar transistor.

17. A DC/DC converter according to claim 6, wherein the under voltage lockout circuit includes a comparator.

18. A DC/DC converter according to claim 17, wherein the comparator is an operational amplifier.

19. A DC/DC converter according to claim 5, wherein the voltage control circuit includes an operational amplifier.

20. A DC/DC converter according to claim 5, wherein the voltage control circuit includes an operational amplifier, a reference voltage connected to one input of the operational amplifier and the output voltage of the secondary winding connected to the other terminal of the operational amplifier.

21. A DC/DC converter according to claim 20, wherein the input voltage is connected to another terminal of the operational amplifier through a resistor so that the voltage of the secondary winding of the flyback transformer is decreased as the input voltage increases.

22. A flyback converter comprising:
a flyback transformer having a primary winding and a secondary winding;
a first switching device for providing a primary voltage to the primary winding of the flyback transformer;
a switching circuit arranged to cyclically turn the first switching device ON and OFF to cyclically apply the primary voltage to the primary of the transformer; and
a voltage control circuit for sensing a secondary voltage at the secondary winding of the flyback transformer, comparing the secondary voltage of the secondary winding to a reference voltage, and generating an error signal to control the magnitude of the primary voltage applied to the primary winding of the flyback transformer.

23. A flyback converter according to claim 22, further comprising means for receiving an input voltage, and an under voltage lockout circuit for disabling the switching circuit from turning the first switching device ON if the input voltage is lower than a predetermined value.

24. A flyback converter according to claim 23, further including means for changing the predetermined value.

25. A flyback converter according to claim 23, wherein the switching circuit comprises second and third switching devices, the second switching device being arranged to turn the first switching device ON and OFF and the third switching device being arranged to turn the second switching device ON and OFF.

26. A flyback converter according to claim 25, wherein the third switching device is connected to the under voltage lockout circuit such that the under voltage lockout circuit turns ON the third switching device if the input voltage is above the predetermined value and turns OFF the third switching device if the input voltage is below the predetermined value.

27. A flyback converter according to claim 23, wherein the under voltage lockout circuit comprises an operational amplifier and the input voltage is connected to one of the inputs of the operational amplifier through a voltage divider.

28. A flyback converter according to claim 23, wherein the under voltage lockout circuit includes an ON/OFF terminal connected to said one input of the operational amplifier through a resistor.

29. A flyback converter according to claim 28, wherein a resistor is connected from the ON/OFF terminal to ground to change the predetermined value.

30. A flyback converter according to claim 25, wherein the first and third switching devices are MOSFETs.

31. A flyback converter according to claim 30, wherein the second transistor is a bipolar transistor.

32. A flyback converter according to claim 30, wherein a resistor is provided for sensing current through the primary winding of the flyback transformer and the resistor is connected to the bipolar transistor.

33. A flyback converter according to claim 23, wherein the lockout circuit includes a comparator.

34. A flyback converter according to claim 33, wherein the comparator is an operational amplifier.

35. A flyback converter according to claim 22, wherein the voltage control circuit includes an operational amplifier.

36. A flyback converter according to claim 22, wherein the voltage control circuit includes an operational amplifier, a reference voltage connected to one input of the operational amplifier and the output voltage of the secondary winding connected to the other terminal of the operational amplifier.

37. A flyback converter according to claim 36, wherein the input voltage is connected to another terminal of the operational amplifier through a resistor so that the voltage of the secondary winding of the flyback transformer is decreased as the input voltage increases.

38. A multi-phase buck regulator DC/DC converter comprising:
a plurality of buck regulator power sections, the outputs of which are connected in parallel and connected to an output load circuit; and
a controller for providing pulse width modulation (PWM) signals to each power section, the PWM signals to each power section being shifted by 360°/n from each other, where n the number of buck regulator power sections.

39. A multi-phase buck regulator DC/DC converter according to claim 38, wherein the PWM signals to each power section are in phase with each other.

40. A multi-phase buck regulator DC/DC converter according to claim 39, wherein the PWM signals to each power section are out of phase with each other.

41. A multi-phase buck regulator DC/DC converter according to claim 38, wherein each of the buck regulator power sections includes gate driven switching devices.

42. A multi-phase buck regulator DC/DC converter according to claim 41, further comprising an auxiliary regulator to provide gate drive voltages to the power sections.

43. A multi-phase buck regulator DC/DC converter according to claim 42, wherein the auxiliary regulator can either increase or decrease an input voltage to provide gate drive voltages to the power stages.

44. A multi-phase buck regulator DC/DC converter according to claim 42, wherein the auxiliary regulator lowers the auxiliary voltage as an input voltage to the auxiliary regulator increases.

45. A multi-phase buck regulator DC/DC converter according to claim 42, wherein the auxiliary regulator lowers the auxiliary voltage as an output load current decreases.

46. multi-phase buck regulator DC/DC converter according to claim 42, wherein the auxiliary regulator is a flyback converter.

47. A multi-phase buck regulator DC/DC converter according to claim 46, wherein the flyback converter comprises:
a primary winding and a secondary winding;
a first switching device for providing a primary voltage to the primary winding of the flyback transformer;
a switching circuit arranged to cyclically turn the first switching device ON and OFF to cyclically apply the primary voltage to the primary of the transformer; and
a voltage control circuit for sensing a secondary voltage at the secondary winding of the flyback transformer, comparing the secondary voltage of the secondary winding to a reference voltage, and generating an error signal to control the magnitude of the primary voltage applied to the primary winding of the flyback transformer.

48. A multi-phase buck regulator DC/DC converter according to claim 47, wherein the flyback converter further comprises means for receiving an input voltage, and an under voltage lockout circuit for disabling the switching circuit from turning the first switching device ON and OFF if the input voltage is lower than a predetermined value.

49. A multi-phase buck regulator DC/DC converter according to claim 47, wherein the flyback converter further includes means for changing the predetermined value.

50. A multi-phase buck regulator DC/DC converter according to claim 47, wherein the switching circuit comprises second and third switching devices, the second switching device being arranged to turn the first switching device ON and OFF and the third switching device being arranged to turn the second switching device ON and OFF.

51. A multi-phase buck regulator DC/DC converter according to claim 50, wherein the third switching device is connected to the under voltage lockout circuit such that the under voltage lockout circuit turns ON the third switching device if the input voltage is above the predetermined value and turns OFF the third switching device if the input voltage is below the predetermined value.

52. A multi-phase buck regulator DC/DC converter according to claim 48, wherein the under voltage lockout circuit comprises an operational amplifier and the input voltage is connected to one of the inputs of the operational amplifier through a voltage divider.

53. A multi-phase buck regulator DC/DC converter according to claim 48, wherein the under voltage lockout circuit includes an ON/OFF terminal connected to said one input of the operational amplifier through a resistor.

54. A multi-phase buck regulator DC/DC converter according to claim 53, wherein the resistor is connected from the ON/OFF terminal to ground to change the predetermined voltage.

55. A multi-phase buck regulator DC/DC converter according to claim 50, wherein the first and third switching devices are MOSFETs.

56. A multi-phase buck regulator DC/DC converter according to claim 55, wherein a second transistor is a bipolar transistor.

57. A multi-phase buck regulator DC/DC converter according to claim 55, wherein a resistor is provided for sensing current through the primary winding of the flyback transformer and the resistor is connected to the bipolar transistor.

58. A multi-phase buck regulator DC/DC converter according to claim 47, wherein the flyback converter further includes means for generating a feedback voltage proportional to the output current of the buck regulator power sections and for inputting this feedback voltage control circuit to change the magnitude of the reference voltage.

59. A multi-phase buck regulator DC/DC converter according to claim 48, wherein the under voltage lockout circuit includes a comparator.

60. A multi-phase buck regulator DC/DC converter according to claim 59, wherein the comparator is an operational amplifier.

61. A multi-phase buck regulator DC/DC converter according to claim 47, wherein the voltage control circuit includes an operational amplifier.

62. A multi-phase buck regulator DC/DC converter according to claim 47, wherein the voltage control circuit includes an operational amplifier, a reference voltage connected to one input of the operational amplifier and the output voltage of the secondary winding connected to the other terminal of the operational amplifier.

63. A multi-phase buck regulator DC/DC converter according to claim 62, wherein the input voltage is connected to said other terminal through a resistor so that the voltage of the secondary winding of the flyback transformer is decreased as the input voltage increases.
